(19) United States
(12) Patent Application Publication
(10) Pub. No.: US 2023/0121029 A1
(43) Pub. Date: Apr. 20, 2023

(54) WIRELESS CONTROL MOUNT

(71) Applicant: SRAM, LLC, Chicago, IL (US)

(72) Inventors: SAGE HAHN, CHICAGO, IL (US); RENEE WESLING, LOMBARD, IL (US)

(73) Assignee: SRAM, LLC, Chicago, IL (US)

(21) Appl. No.: 17/502,301

(22) Filed: Oct. 15, 2021

(51) Int. Cl. B62K 23/02; B62J 45/00

(52) U.S. Cl. CPC B62K 23/02; B62J 45/00

(57) ABSTRACT

A mount for a control device for a bicycle includes a securing portion disposable at least partially around an outer surface of a handlebar of the bicycle, a housing portion extending away from the securing portion, and a cavity within at least the housing portion, the control device being disposable within the cavity, wherein the housing portion includes a shoulder that defines an opening through the housing portion to the cavity, such that an opening size of the opening is smaller than an opening size of the cavity.

### FIELD OF THE DISCLOSURE

The present disclosure is generally directed to a mount for a device, such as a control, on a bicycle.

### DESCRIPTION OF RELATED ART

A bicycle may include one or more components managed by control devices. The components may include, for example, a seat post, a front derailleur, a rear derailleur, or a light. The control device may communicate with the components wirelessly. A user of the bicycle may interact with the control device. To facilitate the user interaction, the control device may be mounted to the bicycle, for example, to the handlebars.

### SUMMARY

In one example, a mount for a control device for a bicycle includes a securing portion disposable at least partially around an outer surface of a handlebar of the bicycle, a housing portion extending away from the securing portion, and a cavity within at least the housing portion. The housing portion includes a shoulder that defines an opening through the housing portion to the cavity, and a size of the opening is smaller than a size of the cavity.

In one example, the control device is a wireless transmitter, and the cavity is configured to receive the wireless transmitter.

In one example, the securing portion includes a first fastener receiving portion and a second fastener receiving portion opposite the first fastener receiving portion.

In one example, the securing portion includes a third fastener receiving portion and a fourth fastener receiving portion opposite the third fastener receiving portion.

In one example, the securing portion and the housing portion are different portions of a single part.

In one example, the housing portion is a housing separate from the securing portion.

In one example, the securing portion is a grip for the handlebar. The grip for the handlebar is disposable completely around the outer surface of the handlebar.

In one example, the grip is formed from a first material, and the housing is formed from a second material different than the first material.

In one example, the first material is rubber, and the second material is a radiotransparent material.

In one example, a mount for a control device for a bicycle includes a body disposable at least partially around a surface of a handlebar of the bicycle, a cavity within the body, a ridge extending away from the body and over the cavity. A surface of the body has a first contour corresponding in shape to a surface of the handlebar, and a second contour corresponding in shape to the surface of the handlebar. The first contour extends in a first direction, and the second contour extends in a second direction, the second direction being at an angle relative to the first direction.

In one example, the second direction is perpendicular to the first direction.

In one example, a first fastener receiving portion extends from the body, and a second fastener receiving portion extends from the body and is spaced apart from the first fastener receiving portion.

In one example, the first fastener receiving portion is arranged opposite the second fastener receiving portion with respect to the first direction.

In one example, a third fastener receiving portion extends from the body, and a fourth fastener receiving portion extends from the body and is spaced apart from the third fastener receiving portion.

In one example, the third fastener receiving portion is arranged opposite the fourth fastener receiving portion with respect to the second direction.

In one example, the third fastener receiving portion is arranged opposite the first fastener receiving portion with respect to the second direction, and the fourth fastener receiving portion is arranged opposite the second fastener receiving portion with respect to the second direction.

In one example, the mount is connectable to the handlebar via a first band connected to the mount at the first fastener receiving portion and the second fastener receiving portion, and a second band connected to the mount at the third fastener receiving portion and the fourth fastener receiving portion, such that the mount is pressed against the handlebar at the first contour or at the second contour of the surface of the body.

In one example, a mount for a control device for a bicycle includes a securing portion disposable around an outer surface of a handlebar of the bicycle, a housing portion extending away from the securing portion, a cavity within at least the housing portion, an opening through the housing portion to the cavity. The housing portion defines an opening through the housing portion to the cavity, and a size of the opening is smaller than a size of the cavity

In one example, a shoulder extending from the housing portion and defining the opening through the housing portion to the cavity.

In one example, a first fastener receiving portion extends from the securing portion, and a second fastener receiving portion extends from the securing portion. The second fastener receiving portion is disposed opposite the first fastener receiving portion with respect to a central axis of the securing portion.

### BRIEF DESCRIPTION OF THE DRAWINGS

Objects, features, and advantages of the present invention will become apparent upon reading the following description in conjunction with the drawing figures, in which:

FIG. 1 is a side view schematic of a bicycle;

FIG. 2 is a perspective view of a control device and a mount in accordance with the teachings of this disclosure;

FIG. 3 is a perspective view of a control device mount with one securing portion;

FIG. 4 is a side view of the control device mount of FIG. 3;

FIG. 5 is a bottom view of the control device mount of FIG. 3;

FIG. 6 is a perspective view of the control device mount of FIG. 3 installed on a handlebar of a bicycle, such as the bicycle of FIG. 1;

FIG. 7 is a perspective view of a control device mount with an alternate securing portions;

FIG. 8 is a side view of the control device mount of FIG. 7;

FIG. 9 is a top view of the control device mount of FIG. 7;

FIG. 10a is a cross-sectional view of the control device mount of FIG. 7;

FIG. 10b is another cross-sectional view of the control device mount of FIG. 7

FIG. 11 is a perspective view of the control device mount of FIG. 7 installed on a handlebar of a bicycle, such as the bicycle of FIG. 1;

FIG. 12 is a perspective view of another control device mount;

FIG. 13 is an exploded view of the control device mount of FIG. 12;

FIG. 14 is a top view of the control device mount of FIG. 12;

FIG. 15 is a side a side view of the control device mount of FIG. 12;

FIG. 16 is an end view of the control device mount of FIG. 12;

FIG. 17 is a perspective view of a control device installed in the control device mount of FIG. 12;

FIG. 18 is a perspective view of yet another control device;

FIG. 19 is a top view of the control device mount of FIG. 19;

FIG. 20 is a side of the control device mount of FIG. 19;

FIG. 21 is another side view of the control device mount of FIG. 19;

FIG. 22 is another perspective view of the control device mount of FIG. 19; and

FIG. 23 is a perspective view of a control device installed in the control device mount of FIG. 19.

### DETAILED DESCRIPTION OF THE DISCLOSURE

Wireless electronic bicycle components communicate with and/or are controlled by control devices, such as wireless buttons, that may be mounted on a bicycle where the control devices may be accessed by the user. Mounting the control devices to the handlebar of the bicycle, for example, may allow the user to control the electronic components without letting go of the handlebars and potentially losing control of the bicycle. Additionally, mounting devices that attach the control device to the bicycle in different configurations allow the user to optimize placement based on personal preference.

To secure the control device to the bicycle (e.g., to a handlebar), a mount has a space or cavity that is fitted to the shape of a wireless button or control and holds the button in place. Once inserted into the mount, the top face of the button remains open for access to a trigger. The mount includes an overhanging lip around the top face of the button. The button is held in place between the lip and the surface of the handlebar against a bottom surface of the button. Though one design of the wireless button may be shown in the figures, the mount may be adapted to fit any wireless transmission devices or bicycle controls.

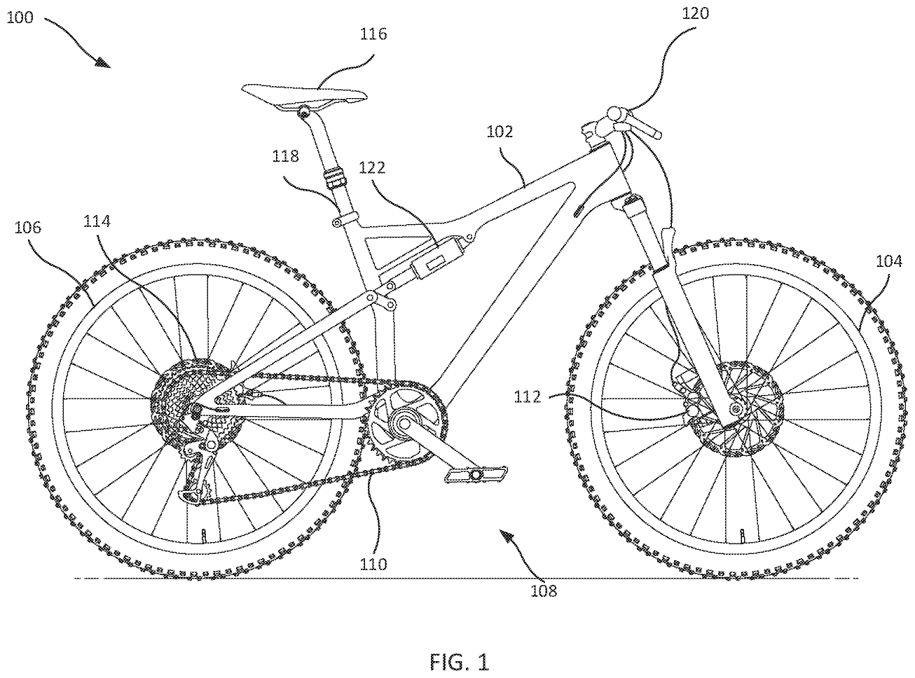

Turning now to the drawings, FIG. 1 generally illustrates one example of a bicycle 100 on which a control device mount of one or more of the present embodiments may be installed. In the example shown, the bicycle 100 is a mountain bicycle. The bicycle 100 has a frame 102 supported on a front wheel 104 and a rear wheel 106. A drivetrain 108 is arranged to provide power to the rear wheel 106 via a chain 110. A front brake 112 and a rear brake 114 are arranged to slow rotation of the front wheel 104 and the rear wheel 106, respectively. A saddle 116 is provided to support the rider during use of the bicycle 100. A seat post assembly 118 secures the saddle 116 to the frame 102. The seat post assembly 118 may be adjustable in height, thereby adjusting the height of the saddle 116. The height of the seat post assembly 118 may be manually or automatically changed. A handlebar 120 is arranged to control a direction of the front wheel 104 and communicate with the drivetrain 108, the front brake 112, and the rear brake 114 to control operation thereof. Further, a suspension component 122, such as a spring, a damper, or a combination thereof, may be attached to the frame 102 to improve ride quality.

A control device, such as a wireless transmitter, may be secured by a mount to the handlebar 120, and is described in greater detail below. The drivetrain 108, seat post assembly 118, suspension component 122, or another component of the bicycle 100 may be controlled by the control device. For example, the control device may instruct the drivetrain 108 to shift a gear, the seat post assembly 118 to change in height, the suspension component 122 to adjust a damping force, or another action.

The components of the bicycle may communicate with the control device through a wired or wireless connection. In one case, the control device may include a wireless transmitter and/or receiver facilitating communication with components of the bicycle 100. The components of the bicycle 100 may include or be in communication with a wireless transmitter and/or receiver. Messages may be relayed wirelessly between the control device and the components and include commands, statuses, and other information. In another case, the control device may communicate with the components via a wired connection. For example, the messages may be routed between the control device and the components through the wired connection.

It is to be understood that the specific arrangement and illustrated components of the frame 102, front wheel 104, rear wheel 106, drivetrain 108, front brake 112, rear brake 114, saddle 116, seat post assembly 118, handlebar 120, and suspension component 122 are merely exemplary. For example, while the front brake 112 and the rear brake 114 are illustrated as hydraulic disc brakes, hydraulic rim brakes are contemplated and encompassed within the scope of the disclosure. In another example, while the handlebar 120 is illustrated as a straight bar, curved handlebars are contemplated and encompassed within the scope of the disclosure

While the bicycle 100 depicted in FIG. 1 is a mountain bicycle (e.g., with straight handlebars 120), the control device mount 201, including the specific embodiments and examples disclosed herein as well as alternative embodiments and examples, may be implemented on other types of bicycles. For example, the disclosed control device mount may be used on road bicycles.

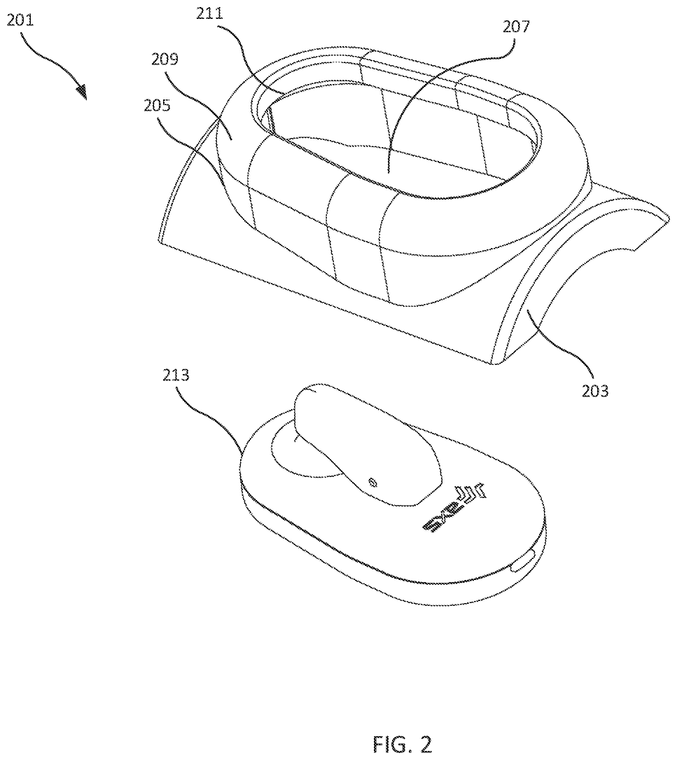

Referring to FIG. 2, an exploded view of a mount 201 and a control device 213 is shown. The mount 201 includes a securing portion 203, a housing portion 205, a cavity 207, a shoulder 209, and an opening 211.

The securing portion 203 is a body that is disposable on the handlebar 120 to secure the mount 201 to the handlebar 120. The securing portion 203 may extend at least partially along a surface of the handlebar 120. Though an extent of the securing portion 203 is shown in FIG. 2, the securing portion 203 may extend further or lesser around the handlebar 120. The securing portion 203 may be configured to follow a contour of an outer surface of the handlebar 120.

For example, a body of the securing portion 203 may be a cylindrical sector (e.g., circular cylindrical or elliptic cylindrical) that is hollow. The cylindrical sector has an outer surface and an inner surface. The outer surface of the body of the securing portion 203 is closer to the housing portion 205 than the inner surface of the body of the securing portion 203 is relative to the housing portion 205. The inner surface of the body of the securing portion 203 may abut the handlebar 120 when the mount 201 is secured to the handlebar 120. A length of the securing portion 203 (e.g., the cylindrical sector) may extend along the handlebar 120 when the securing portion 203 is secured to the handlebar 120. Other shapes and orientations may be provided.

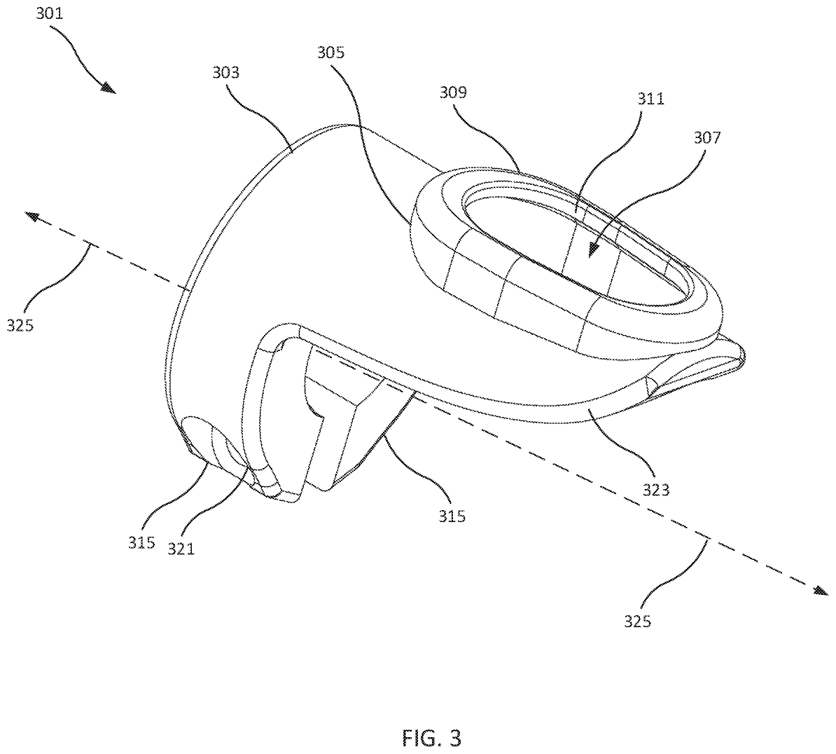

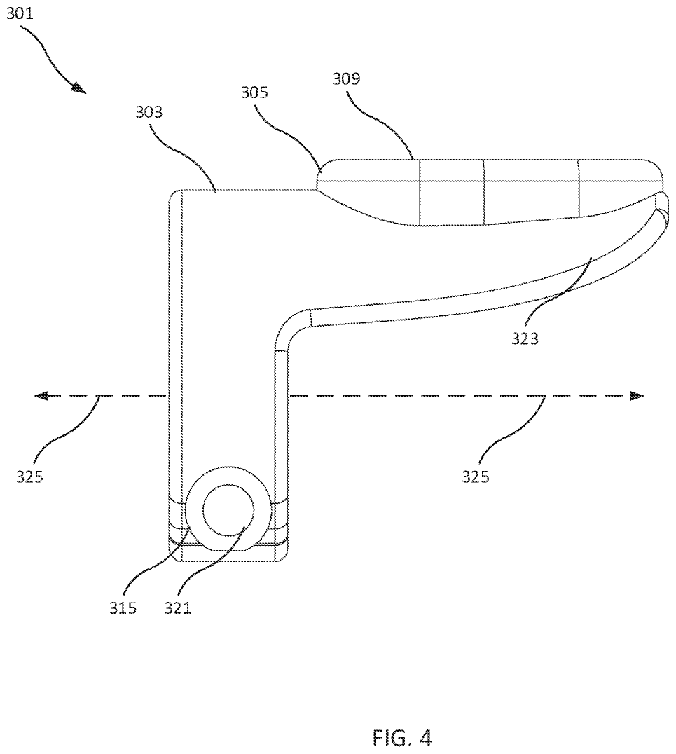

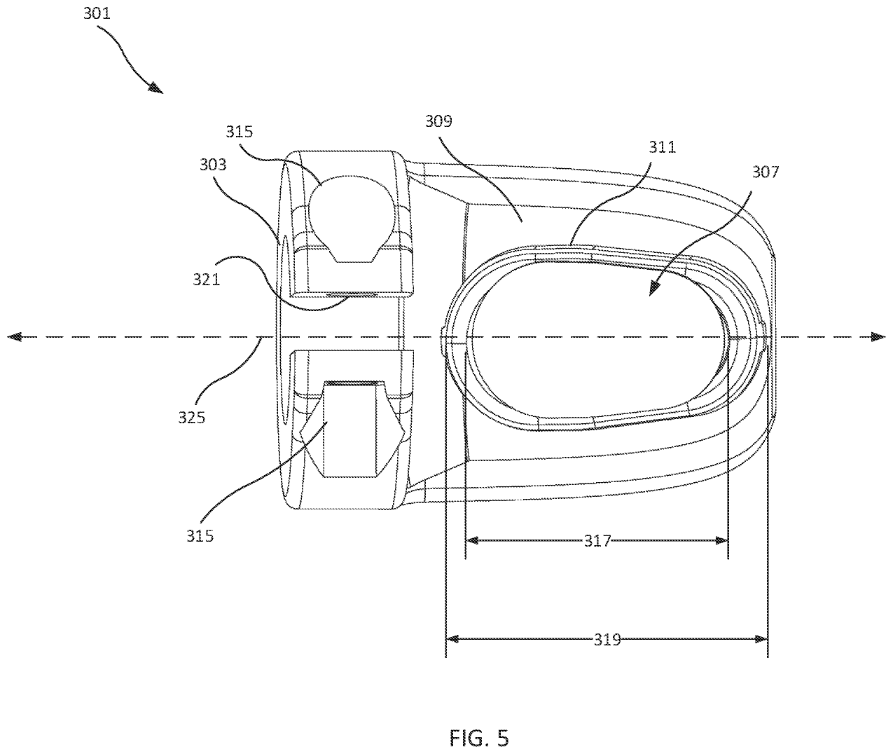

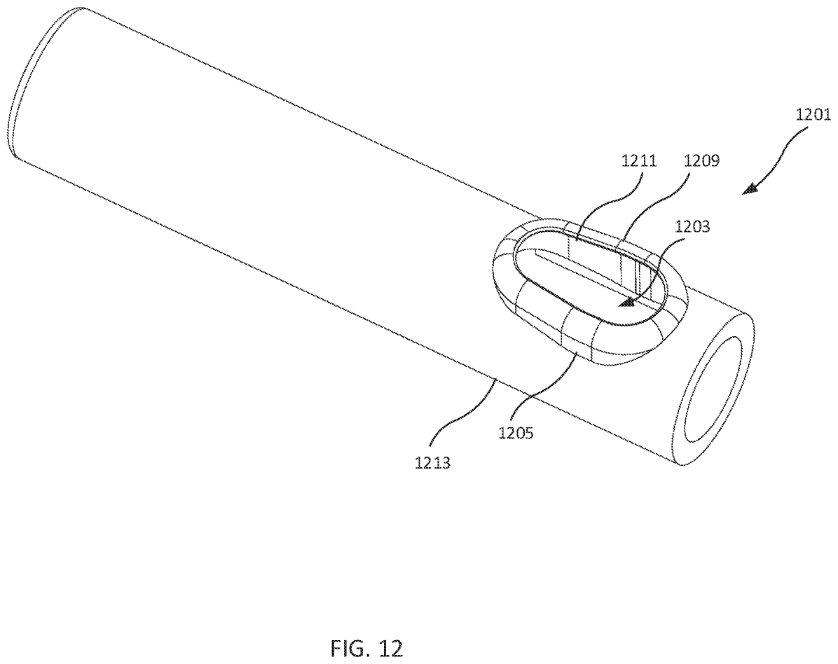

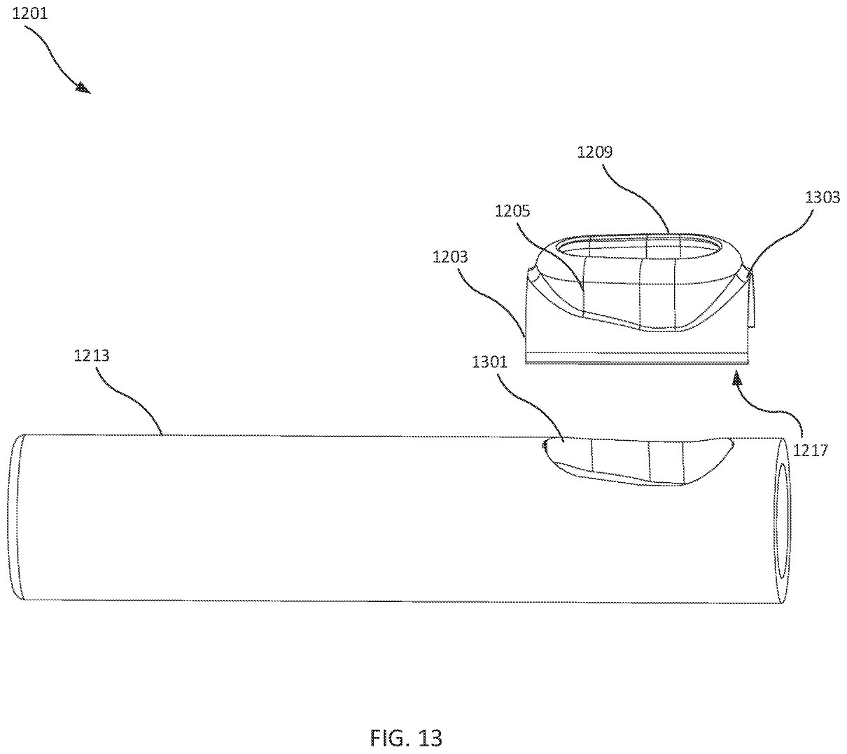

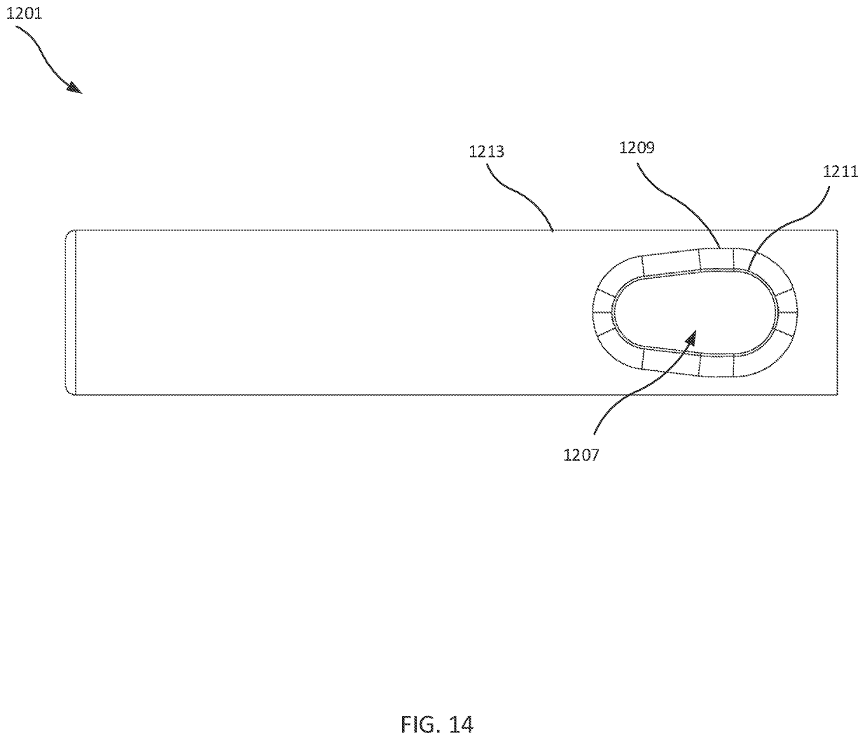

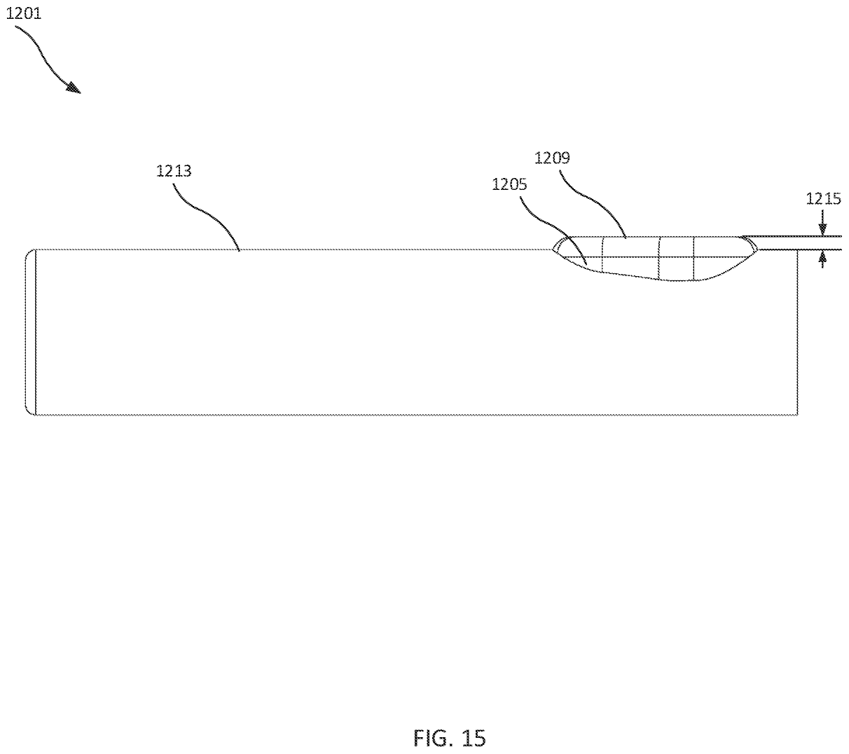

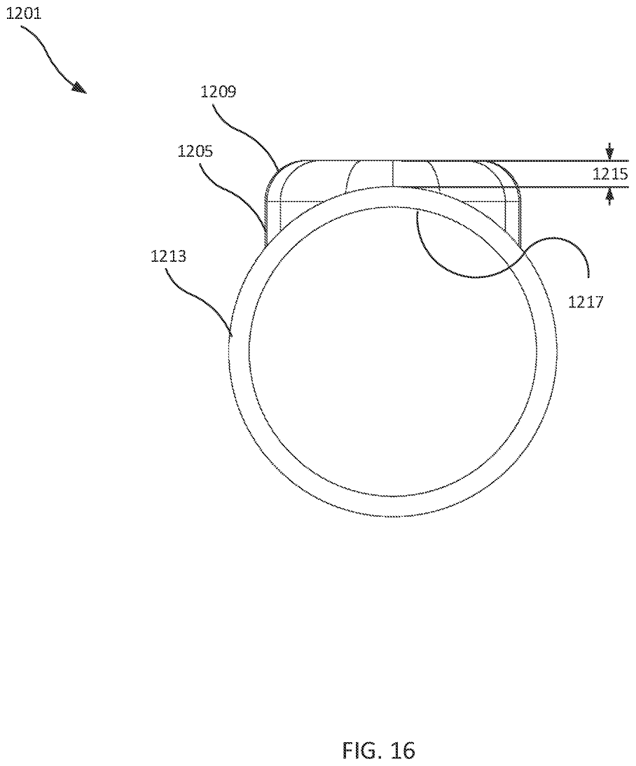

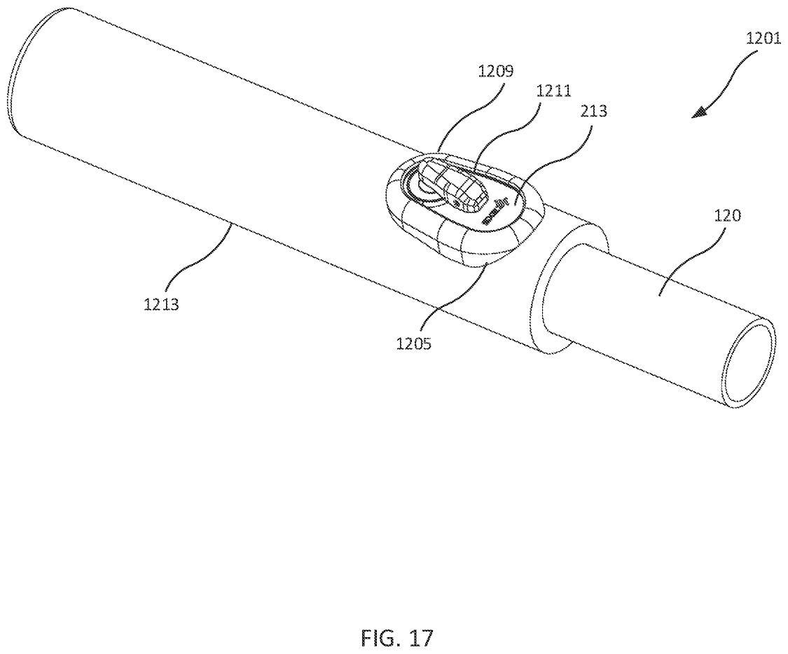

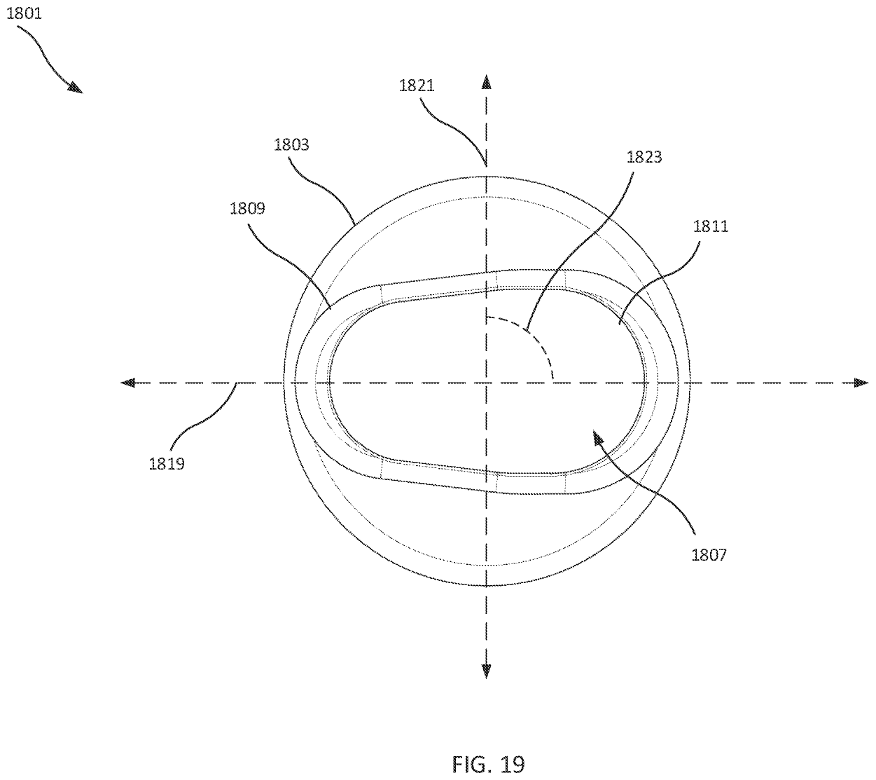

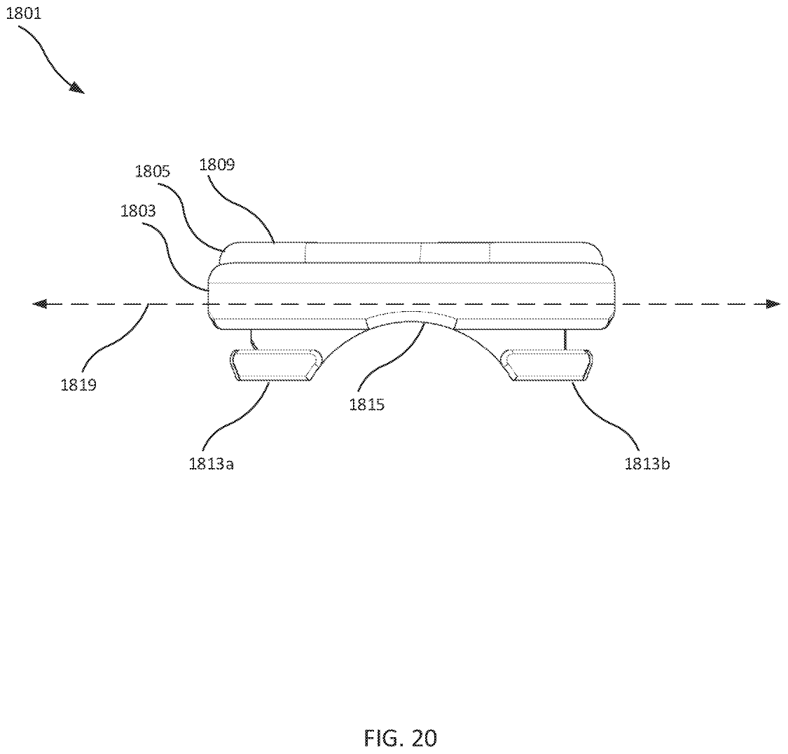

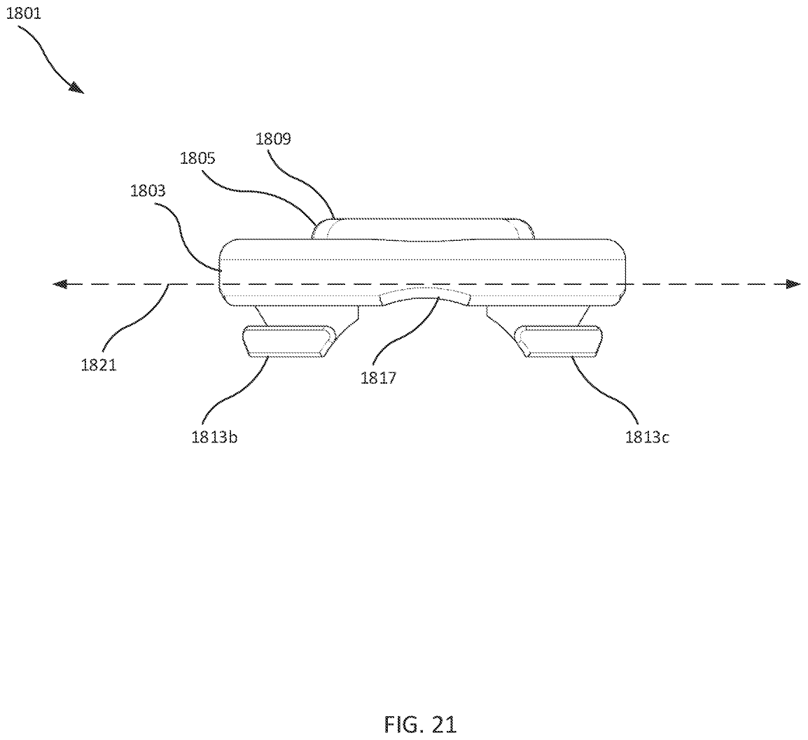

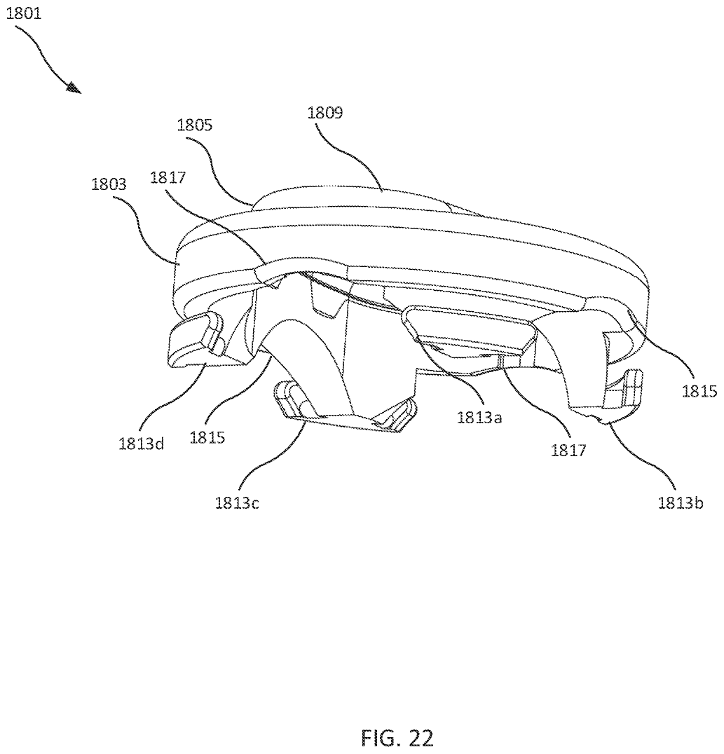

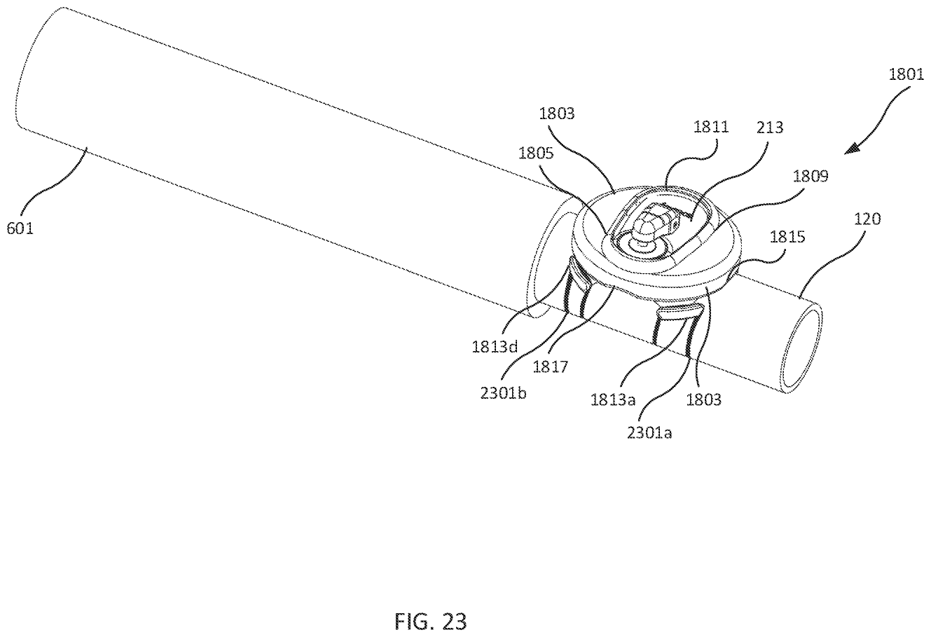

The housing portion 205 may extend from the securing portion 203. The securing portion 203 and the housing portion 205 may be different portions of a single part. For example, as discussed below with respect to FIGS. 3-11 and 18-23, the securing portion 203, 303, 703, 1803 and the housing portion 205, 305, 705, 1805 form a single part. Alternatively, as discussed below with respect to FIGS. 12-17, the securing portion 203, 1203 may be a separate part from the housing portion 205, 1205.

The cavity 207 may be configured to receive the control device 213. For example, the control device 213 may be disposed or positioned partially or fully within the cavity 207. The size and shape of the cavity 207 matches one design of the control device 213, for example, an asymmetrical oval shape with a small rectangular extrusion on each side. However, the size and shape of the cavity 207 may be adapted to fit any model or multiple models of a control device 213.

The shoulder 209 may retain the control device 213 disposed in the cavity 207. In some cases, the cavity 207 may be dimensioned to allow for different orientations of the control device 213 within the cavity 207. Additionally or alternatively, the mount 201 (e.g., the securing portion 203) may be disposed in different orientations on the handlebar 120, thereby allowing for versatile positioning of the control device 213. For example, the mount 201 may be positioned at any number of positions around and/or along the handlebar 120.

The control device 213 may be inserted from a bottom side of the cavity 207 opposite the shoulder 209. Similarly, the control device 213 may be removed from the bottom side of the cavity 207. In this way, the effort to install and remove the control device 213 is reduced. Because the control device is held between the shoulder 209 and the handlebar, the mount 201 and control device 213 may be separated without the use of additional tools. For example, a user may adjust or replace the control device 213 in the field more easily. The simple installation provides an additional benefit because the control device may be serviced (e.g., to replace a battery) or replaced periodically.

The shoulder 209 defines an opening 211 through the housing portion 205 to the cavity 207, such that an opening size of the opening 211 is smaller than an opening size of the cavity 207. In some cases, the shoulder 209 may be a lip, overhang, a ridge, a flange, or another extrusion from the housing portion 205 into or over the cavity 207 that retains the control device 213 in the housing portion 205. The control device 213 is then secured in the cavity 207, between the shoulder 209 extending over the face or upper surface of the control device 213 and the handlebar 120.

The shoulder 209 may be any number shapes and/or sizes. In one embodiment, the shoulder 209 is configured such that a cross-section of the opening 211 defined by the shoulder 209 is a same shape as a cross-section of the cavity 207 (e.g., in planes parallel to each other) but is smaller than the cross-section of the cavity 207. In another embodiment, the cross-section of the opening 211 is a different shape the cross-section of the cavity 207. The shoulder 209 may have any number of thicknesses

Referring to FIGS. 3-6, The mount 301 includes a securing portion 303, a housing portion 305, a cavity 307, a shoulder 309, and an opening 311. The securing portion 303 is a body that is disposable on the handlebar 120 to secure the mount 301 to the handlebar 120. The securing portion 303 may extend at least partially along a surface of the handlebar 120 and may match the contours of the handlebar 120. A body of the securing portion 303 may be a cylindrical sector that is hollow.

The housing portion 305 may extend from the securing portion 303. For example, the housing portion 305 may extend outwardly from the securing portion 203 in a radial direction with respect to a central axis 325 of the securing portion 303 and/or a central axis 603 of the handlebar 120 to which the securing portion 303 is securable.

The cavity 307 may be configured to receive the control device 213. For example, the control device 213 may be disposed or positioned partially or fully within the cavity 307. The shoulder 309 defines an opening 311 through the housing portion 305 to the cavity 307, such that an opening size of the opening 311 is smaller than an opening size of the cavity 307. In one example, a span 317 (e.g., a diameter) of the opening 311 is smaller than a span 319 (e.g., a diameter) of the cavity 307 (e.g., in planes parallel to each other). The shoulder 309 may retain the control device 213 disposed in the cavity 307.

The securing portion 303 of the mount 301 may include one or more fastener receiving portions 315 (e.g., extending away from the body of the securing portion 303). In the embodiments shown in FIGS. 3-6, the one or more fastener receiving portions 315 are extensions of, in one example, the cylindrical section of the body of the securing portion 303. The one or more fastener receiving portions may have a greater sector angle than the rest of the securing portion 303. In other words, the fastener receiving portions 315 may extend further around the handlebar 120 than the rest of the body of the securing portion 303 when the mount 301 is disposed on the handlebar 120. In one embodiment, the fastener receiving portions 315, together with the body of the securing portion 303, may extend substantially around the handlebar 120 when the mount 301 is disposed on the handlebar 120. Other shapes of the fastener receiving portions 315 may be provided.

The fastener receiving portions 315 may interface with a fastener and secure the mount 301 to the handlebar 120. The fastener receiving portions 315 may be spaced apart and, when drawn together (e.g., by the fastener), secure the mount 301 to the handlebar 120. The fastener exerts a force on the fastener receiving portions 315 to draw the fastener receiving portions 315 together. The fastener may include, for example, a screw, a bolt, a pin, a nut, an elastomer, a zip tie, and/or another fastener. In FIGS. 3-6, the mount 301 includes a pair of fastener receiving portions 315 that extend from or are a part of the securing portion 303. A first fastener receiving portion 315 of the pair may be arranged opposite from a second fastener receiving portion 315 of the pair with respect to the central axis 325 of the securing portion 303. A fastener may bring the pair of fastener receiving portions 315 together and tighten the mount 301 to the handlebar 120.

The fastener receiving portions 315 may include a passage 321 through which the fastener may extend. The passage 321 may include threads, ridges, keyways, or other features. The fastener may, in one example, engage the threads, ridges, keyways or other feature of the passage 321. In another example, the fastener may extend through the passage 321 without engaging the passage 321.

In some cases, the fastener receiving portions 315 may be recessed in the securing portion 303. For example, the fastener receiving portions 315 may be disposed inward of an outer surface of the securing portion 303. As a result, the extent to which fasteners disposed in the fastener receiving portions 315 protrude beyond the securing portion 303 may be reduced. By recessing the fastener receiving portions 315 into the securing portion 303 (thereby recessing the fasteners disposed in the fastener receiving portions 315), the fasteners may be protected by the securing portion 303 from debris, corrosion, and wear.

The securing portion 303 may include a contour 323. The contour 323 extends along an edge of the securing portion 303 and defines an extent of the securing portion 303. As illustrated in FIGS. 3-6, a first end of the securing portion 303 extends around the handlebar 120 to a greater extent that at a second end of the securing portion 303 opposite the first end. By varying the extent of the securing portion 303, the ergonomics of the mount 301 are improved. In one example, a shape of the contour 323 is curved, rounded, or sloped/angled up from the grip 601.

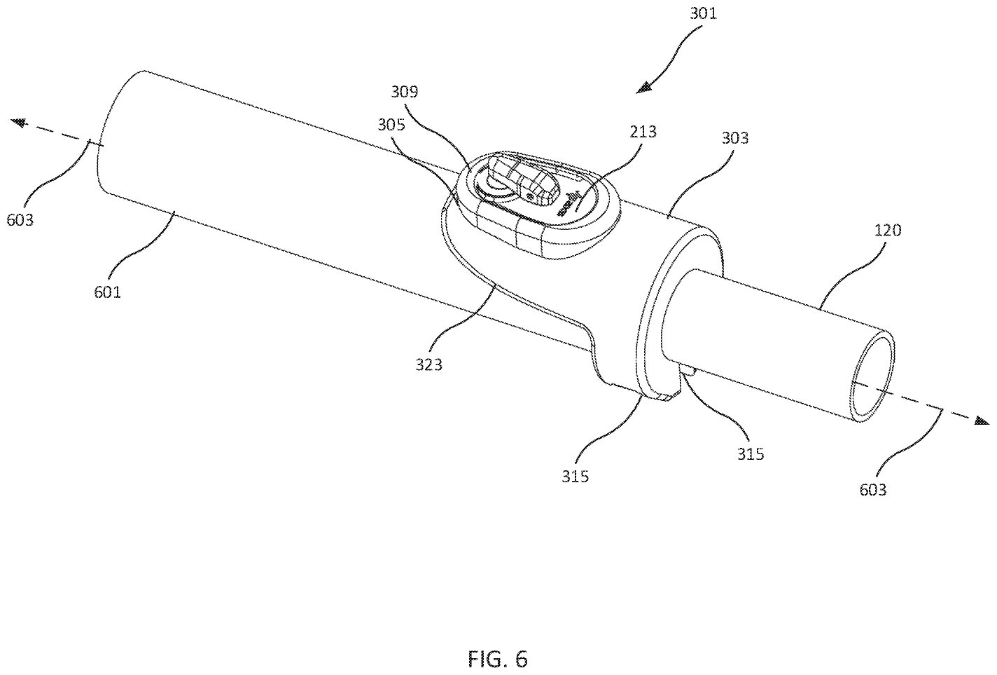

In FIG. 6, the mount 301 is secured to a handlebar 120, and the control device 213 is installed in the cavity 307. When installed in the cavity 307, a bottom surface of the control device 213 is held flush against either the surface of the handlebar 120 or a surface of a grip 601. The mount 301 may be secured at any angle around the circumference of the handlebar 120. This allows the user to customize the angle at which the control device 213 is held according to personal preference and for optimal user comfort.

In this example, the mount 301 is disposed over the grip 601 on the handlebar 120. The grip 601 may have an elongated tube shape. Because the fastener receiving portions 315 are disposed toward an axial end of the securing portion 303, the mount 301 may be secured adjacent to the grip 601 of the handlebar 120. The position of the fastener receiving portions 315 allows for the control device 213 to be held over the grip 601 and in a convenient position for the user.

In this example, the mount 301 (or the securing portion 303) is separate from the grip 601. In some other cases, for example, as described with respect to FIGS. 12-17 below, the securing portion 303, 1203 may include the grip 601. While the mount 301 may be configured to fit around a radius of the outer circumference of mountain bike handlebars 120, the mount 301 may be shaped to fit around the grip 601, a wider inboard portion of the handlebar 120, the stem, the frame 102, or any other part of the bicycle 100.

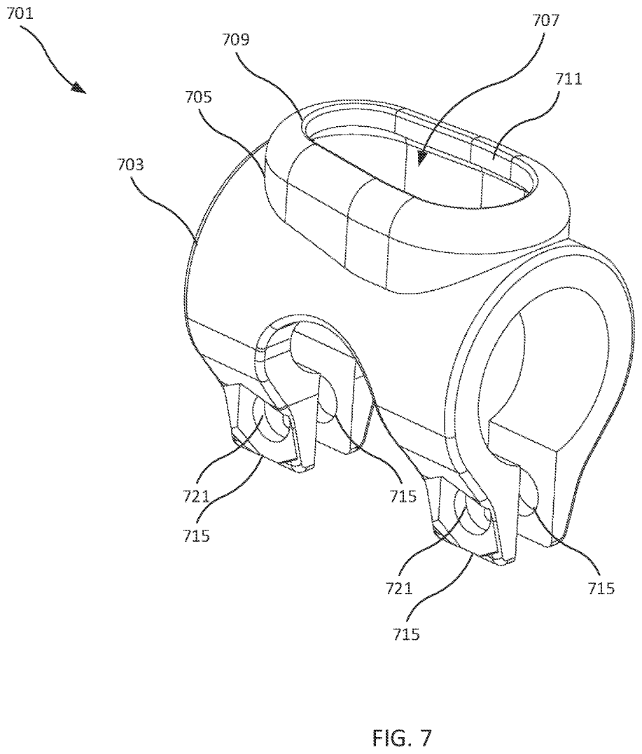

In FIGS. 7-11, the mount 701 includes a securing portion 703, a housing portion 705, a cavity 707, a shoulder 709, and an opening 711. The securing portion 703 is a body that is disposable on the handlebar 120 to secure the mount 701 to the handlebar 120. The securing portion 703 may extend at least partially along a surface of the handlebar 120 and may match the contours of the handlebar 120. A body of the securing portion 703 may be a cylindrical sector that is hollow.

The housing portion 705 may extend from the securing portion 703. The cavity 707 may be configured to receive the control device 213. For example, the control device 213 may be disposed or positioned partially or fully within the cavity 707.

The shoulder 709 defines an opening 711 through the housing portion 705 to the cavity 707, such that an opening size of the opening 711 is smaller than an opening size of the cavity 707. The shoulder 709 may retain the control device 213 disposed in the cavity 707.

The mount 701 includes two pairs of fastener receiving portions 715 that extend from or are a part of the securing portion 703. The two pairs of fastener receiving portions 715 may be arranged opposite one another (e.g., at opposite ends of the securing portion 703). For example, within each pair of fastener receiving portions 715, a first fastener receiving portion 715 of the pair may be arranged opposite from a second fastener receiving portion 715 of the pair. In this way, multiple fasteners may extend between or otherwise enact a force on the pairs of fastener receiving portions 715. By using additional fastener receiving portions 715, the mount 701 may be more solidly secured to the handlebar 120, thereby reducing the risk of the mount 701 and control device 213 changing positions over time or under demanding use conditions.

The fastener receiving portions 715 may include a passage 721 through which the fastener may extend. The passage 721 may include threads, ridges, keyways, or other features. The fastener may, in one example, engage the threads, ridges, keyways or other feature of the passage 721. In another example, the fastener may extend through the passage 721 without engaging the passage 721.

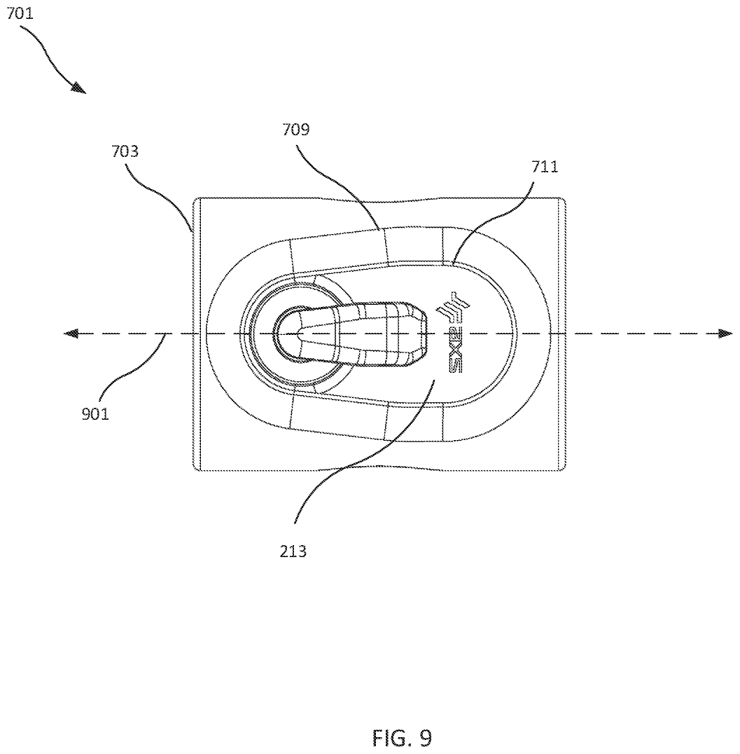

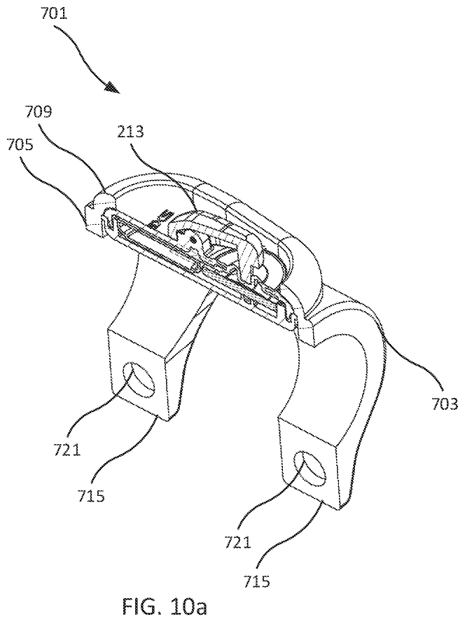

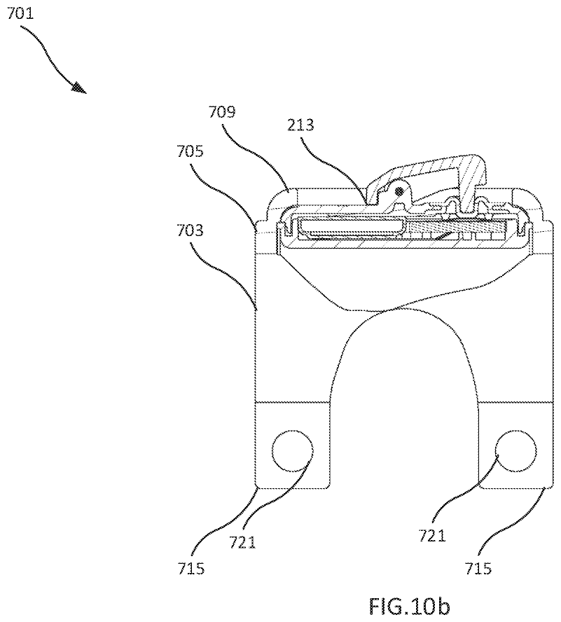

The control device 213 is positioned in the mount 701. FIGS. 10a and 10b are cross sections of FIG. 9 as cut along an axis 901. The shoulder 709 extends over a first surface of the control device 213. When the mount 701 is disposed on the handlebar 120, a second surface of the control device 213 abuts or is adjacent to the handlebar 120. Because the control device 213 is disposed between the shoulder 709 and the handlebar 120, the control device 213 is secured in the mount 701.

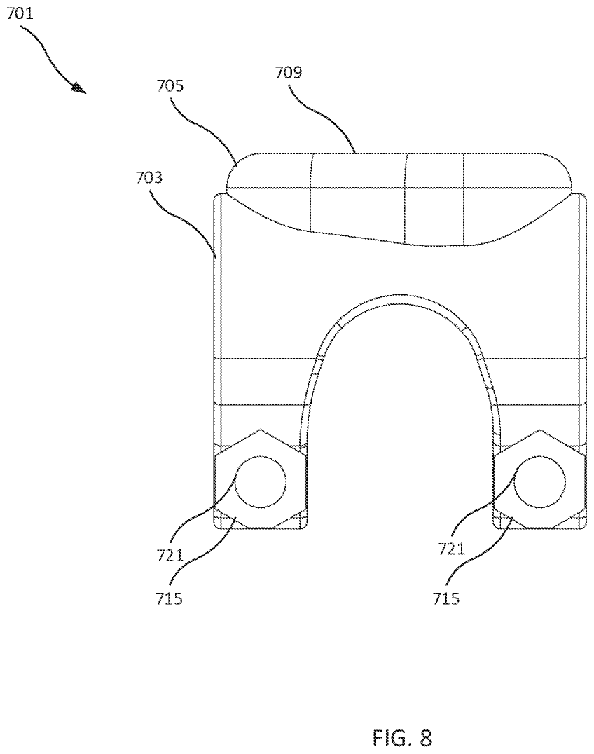

The fastener receiving portions 715 may be distributed along the axis 901. In one example, a first pair of fastener receiving portions 715 is located on a first side of the cavity 707 with respect to the axis 901, and a second pair of fastener receiving portions 715 is located further along the axis 901, on a second side of the cavity 707 (e.g. as shown in FIG. 8). In another example, both pairs of fastener receiving portions 715 are disposed on one side of the cavity with respect to the axis 901.

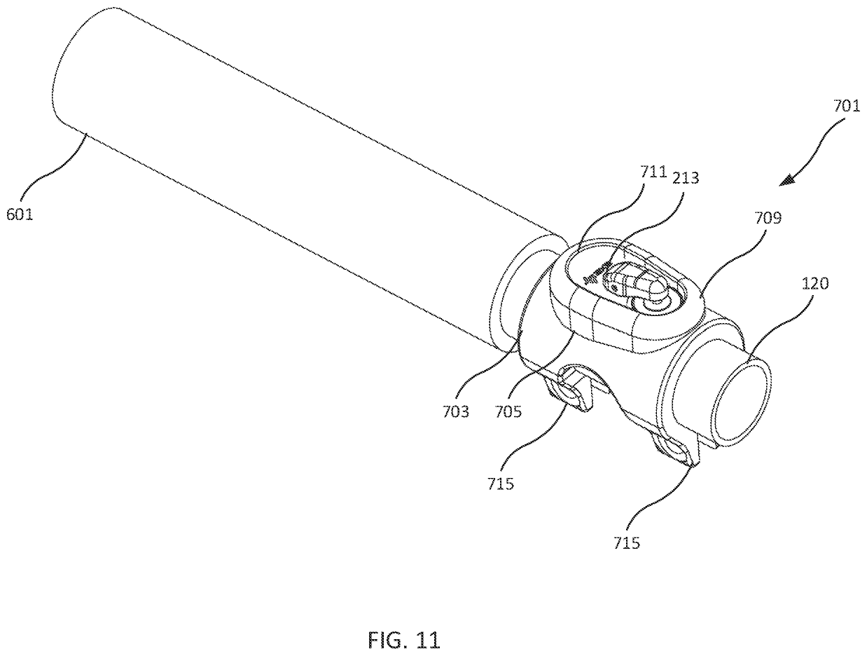

Although shown in FIG. 11 as being secured directly to the handlebar 120, in an alternate example the mount 701 may be secured over the grip 601.

Referring to FIGS. 12-17, a mount 1201 includes a securing portion 1203, a housing portion 1205, a cavity 1207, a shoulder 1209, and an opening 1211. The securing portion 1203 is a body that is disposable on the handlebar 120 to secure the mount 1201 to the handlebar 120. The securing portion 1203 may extend at least partially along a surface of the handlebar 120 and may match the contours of the handlebar 120. A body of the securing portion 1203 may be a cylindrical sector that is hollow. The housing portion 1205 may extend from the securing portion 1203.

The cavity 1207 may be configured to receive the control device 213. For example, the control device 213 may be disposed or positioned partially or fully within the cavity 1207. The shoulder 1209 defines an opening 1211 through the housing portion 1205 to the cavity 1207, such that an opening size of the opening 1211 is smaller than an opening size of the cavity 1207. The shoulder 1209 may retain the control device 213 disposed in the cavity 1207.

The securing portion 1203 of the mount 1201 may integrate a grip 1213 of a handlebar 120. The grip 1213 is disposed completely around an outer surface of the handlebar 120. Friction between the grip 1213 and the handlebar 120 secures the mount 1201 to the handlebar 120.

The securing portion 1203 and the grip 1213 may be made from a different material than the housing portion 205. For example, the housing portion 205 may be made from a first material, such as a rigid, durable material (e.g., a plastic), whereas the grip 1213 and/or the securing portion 1203 may be made from a second material, such as a material with an elastic property (e.g., a flexible rubber). In some cases, the housing portion 1205 may be made from a radiotransparent material and allow for unimpeded wireless communication by the control device 213. An inner diameter of the grip 1213 may be stretched to fit around an outer diameter of the handlebar 120 and hold the mount 1201 in place. In other words, the inner diameter of the grip 1213 may be less than the outer diameter of the handlebar 120.

A visible height extent 1215 of the mount 1201 and the control device 213 depends on a radial thickness of the mount 1201. The grip 1213 in FIGS. 12-17 extends radially outward relative to the handlebar 120 and defines the visible extent 1215 of the mount 1201 beyond the handlebar 120 or grip 1213. Compared to, for example, a visible extent of the mount 201 and the control device 213 shown in FIGS. 2-11 and 18-23, where the securing portion 203 may not include a grip 601, the visible extent 1215 may be reduced by the radial thickness of the mount 1201. The visible extent 1215 of the mount 1201 may improve the comfort of user interaction. For example, a particular visible extent 1215 may place the control device 213 within reach of the finger of the user and provide an ergonomic interaction. However, when the visible extent 1215 is too great, the user may change from a preferred hand position to reach the control device 213. When the visible extent 1215 is too low, the control device 213 may be accidentally actuated.

Additionally or alternatively, the housing portion 1205 and the shoulder 1209 may have a sloped or curved outer surface. In a further example, the shoulder 1209 may have a larger radius from the housing portion 1205 to the opening 1211.

While the securing portion 1203 and the housing portion 1205 may be made from different materials, the securing portion 1203 and the housing portion 1205 may be integrated, as shown in FIGS. 12-17. The housing portion 1205 may include a bottom surface 1217 configured to fit to a curvature of the handlebar 120. The grip 1213 may include a cutout or opening 1301, and the securing portion 1203 may be disposed between the handlebar 120 and the grip 1213, such that the housing portion 1205 protrudes from the cutout or opening 1301 in the grip 1213. A profile 1303 between the housing portion 1205 and the securing portion 1203 may be configured to correspond to the shape and size of the opening 1301. By using corresponding shapes and sizes for the opening 1301 and the profile 1303, the securing portion 1203 may held in position relative to the grip 1213.

By integrating a grip 1213 into the securing portion 1203, additional hardware, such as the fastener receiving portions 215, 715, may be excluded. Additional space on the handlebar may be saved for other control devices, such as brakes.

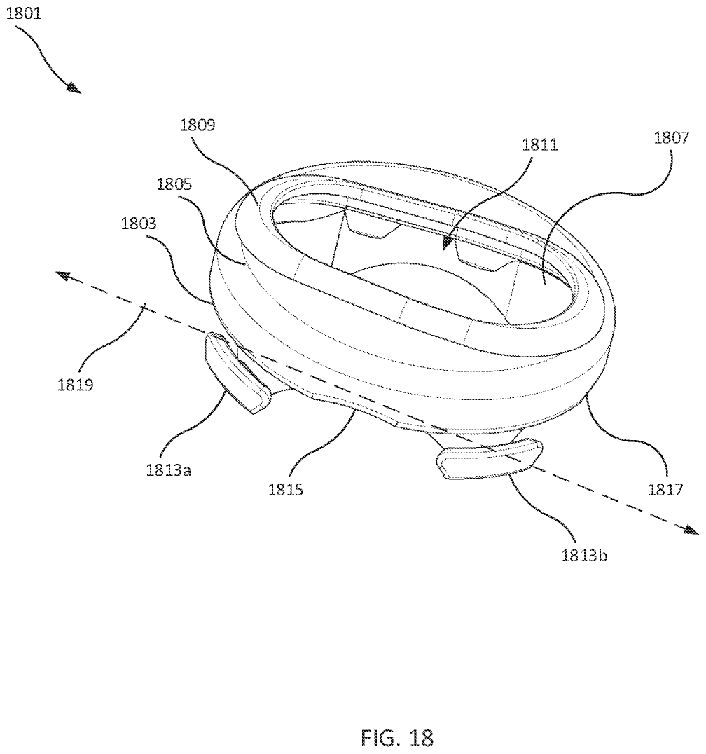

Referring to FIGS. 18-23, a mount 1801 includes a securing portion 1803, a housing portion 1805, a cavity 1807, a shoulder 1809, and an opening 1811. The securing portion 1803 is a body that is disposable on the handlebar 120 to secure the mount 1801 to the handlebar 120. The securing portion 1803 may extend at least partially along a surface of the handlebar 120 and may match the contours of the handlebar 120. A body of the securing portion 1803 may be a cylindrical sector that is hollow. The housing portion 1805 may extend from the securing portion 1803. The cavity 1807 may be configured to receive the control device 213. For example, the control device 213 may be disposed or positioned partially or fully within the cavity 1807. The shoulder 1809 defines an opening 1811 through the housing portion 1805 to the cavity 1807, such that an opening size of the opening 1811 is smaller than an opening size of the cavity 1807. The shoulder 1809 may retain the control device 213 disposed in the cavity 1807.

One embodiment of a mount 1801 may be configured to attach to the handlebar 120 with one or more connectors 2301 (e.g., bands) engaged with fastener receiving portions 1813 extending from the securing portion 1803. The fastener receiving portions 1813 may be configured to receive the bands 2301. The fastener receiving portions 1813 may include a first portion extending downward and/or outward from the securing portion 1803, and a second portion connected to the first portion. The second portion may extend upward vertically, or almost vertically, working to secure the connectors 2301 in place. The second portion may be narrower at its base and wider at the top. The first portion may be wider at its base, the area connecting to the securing portion, and narrow as it moves to the connection point to the second portion. The first portion and second portion of the fastener receiving portions 1813 may be one unitary structure with the securing portion 1803. Alternatively, the first portion and second portion of the fastener receiving portion 1813 may be a unit that is separate from and attachable to the securing portion 1803. The bands 2301 may be rubber bands, string, zip ties, elastomers, or another flexible fastener. The bands 2301 press the mount 1801 (e.g., the contour 1815 and/or the contour 1817) against the handlebar 120.

The mount 1801 sits on the handlebar 120, and a first band 2301a may be hooked onto a first of the fastener receiving portions 1813a. The first band 2301a extends around the handlebar 120 and may be hooked onto a corresponding second fastener receiving portion 1813b.

A second band 2301b may be hooked onto a third fastener receiving portion 1813c spaced apart from and, in one example, opposite the first fastener receiving portion 1813a. The first fastener receiving portion 1813a and the third fastener receiving portion 1813c may be opposite one another with reference to the axis 1819 and/or the axis 1821. The second band 2301b extends around the handlebar 120 (e.g., parallel to the first band 2301a) and may be hooked onto a corresponding fourth fastener receiving portion 1813d. The fourth fastener receiving portion 1813d is spaced apart from and opposite the third fastener receiving portion 1813c. The second fastener receiving portion 1813b and the fourth fastener receiving portion 1813d may be opposite one another with reference to the axis 1819 and/or the axis 1821.

For example, the third fastener receiving portion 1813c is arranged opposite the first fastener receiving portion 1813a (e.g., across one of axis 1819 or axis 1821), and the fourth fastener receiving portion 1813d is arranged opposite the second fastener receiving portion 1813b (e.g., across the other of axis 1819 or axis 1821). In this way, each band 2301 is engaged with multiple fastener receiving portions 1813 that may be disposed opposite one another on the securing portion 1803.

In some cases, the securing portion 1803 may include a single pair of fastener receiving portions 1813 corresponding to a single band 2301. This configuration may reduce on material, manufacturing, packaging, and shipping costs for the mount 1801. In some other cases, the securing portion 1803 may include more than two pairs of fastener receiving portions 1813. For example, the securing portion 1803 may have three, four, or even greater numbers of pairs of fastener receiving portions 1813. The securing portion 1803 with multiple pairs of fastener receiving portions 1813 may be adaptable to a wide variety of handlebars 120, users, and riding styles.

The combination of multiple fastener receiving portions 1813 and one or more bands 2301 that wrap around the handlebar 120 allows for versatile positioning of the control device 213 on the handlebar 120. For example, the mount 1801 may be placed anywhere along the handlebar 120, adjusting a distance between a preferred hand placement of the user and the location of the control device 213. Additionally, the control device 213 may be mounted in an orientation toward, away from, to the left or to the right of the user.

A surface of the securing portion 1803 may have one or more contours 1815, 1817 corresponding in shape to a surface of the handlebar 120. A first contour 1815 may extend in a first direction (e.g., along the axis 1819), and a second contour 1817 may extend in a second direction (e.g. along the axis 1821). In one example, the second direction is at an angle 1823 relative to the first direction. The first direction and second direction may be perpendicular or at a different angle 1823 to each other. The contours 1815, 1817 may have different shapes or curvatures to correspond to a shape of different mounting points, such as different handlebars 120, sections of a handlebar 120 and/or different components of the bicycle 100.

The securing portion 1803 may have a size and shape allowing for ergonomic user interaction. For example, the securing portion 1803 may be generally rounded and devoid of sharp edges or corners. The securing portion 1803 may, in one case, have a generally circular shape. In another case, the securing portion may have one or more complex curves corresponding in shape to the surface of a palm of the rider.

In some cases, the securing portion 1803 may include a single contour 1815. This configuration may reduce material, manufacturing, packaging, and shipping costs for the mount 1801. In some other cases, the securing portion 1803 may include more than two contours 1815, 1817. For example, the securing portion 1803 may have three, four, or even greater numbers of contours 1815, 1817. The multiple contours 1815, 1817 may be arranged in multiple directions (e.g., along axes 1819, 1821) that are perpendicular or non-perpendicular. For example, the contours 1815, 1817 may be arranged in directions that are more than, less than, or equal to 60 degrees of each other. The securing portion 1803 with multiple contours 1815, 1817 may be adaptable to a wide variety of handlebars 120, users, and riding styles.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. For example, a mechanical shift control device may be substituted for the disclosed electronic shift control device. In another example, a mechanical brake control device may be substituted for the disclosed hydraulic brake control device. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations and/or acts are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that any described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

What is claimed is:

1. A mount for a control device for a bicycle, the mount comprising:
a securing portion disposable at least partially around an outer surface of a handlebar of the bicycle;
a housing portion extending away from the securing portion; and
a cavity within at least the housing portion,
wherein the housing portion comprises a shoulder that defines an opening through the housing portion to the cavity, and
wherein a size of the opening is smaller than a size of the cavity.

2. The mount of claim 1, wherein the control device is a wireless transmitter, and the cavity is configured to receive the wireless transmitter.

3. The mount of claim 1, wherein the securing portion comprises a first fastener receiving portion and a second fastener receiving portion opposite the first fastener receiving portion.

4. The mount of claim 3, wherein the securing portion comprises a third fastener receiving portion and a fourth fastener receiving portion opposite the third fastener receiving portion.

5. The mount of claim 1, wherein the securing portion and the housing portion are different portions of a single part.

6. The mount of claim 1, wherein the housing portion is a housing separate from the securing portion.

7. The mount of claim 6, wherein the securing portion is a grip for the handlebar, and
wherein the grip for the handlebar is disposable completely around the outer surface of the handlebar.

8. The mount of claim 7, wherein the grip is formed from a first material, and
wherein the housing is formed from a second material different than the first material.

9. The mount of claim 8, wherein the first material is rubber, and wherein the second material is a radiotransparent material.

10. A mount for a control device for a bicycle, the mount comprising:
a body disposable at least partially around a surface of a handlebar of the bicycle;
a cavity within the body; and
a ridge extending away from the body and over the cavity
wherein a surface of the body has a first contour corresponding in shape to a surface of the handlebar, and a second contour corresponding in shape to the surface of the handlebar, and
wherein the first contour extends in a first direction, and the second contour extends in a second direction, the second direction being at an angle relative to the first direction.

11. The mount of claim 10, wherein the second direction is perpendicular to the first direction.

12. The mount of claim 10, further comprising:
a first fastener receiving portion extending from the body; and
a second fastener receiving portion extending from the body and spaced apart from the first fastener receiving portion.

13. The mount of claim 12, wherein the first fastener receiving portion is arranged opposite the second fastener receiving portion with respect to the first direction.

14. The mount of claim 13, further comprising:
a third fastener receiving portion extending from the body; and
a fourth fastener receiving portion extending from the body and spaced apart from the third fastener receiving portion.

15. The mount of claim 14, wherein the third fastener receiving portion is arranged opposite the fourth fastener receiving portion with respect to the second direction.

16. The mount of claim 15, wherein the third fastener receiving portion is arranged opposite the first fastener receiving portion with respect to the second direction, and the fourth fastener receiving portion is arranged opposite the second fastener receiving portion with respect to the second direction.

17. The mount of claim 14, wherein the mount is connectable to the handlebar via a first band connected to the mount at the first fastener receiving portion and the second fastener receiving portion, and a second band connected to the mount at the third fastener receiving portion and the fourth fastener receiving portion, such that the mount is pressed against the handlebar at the first contour or at the second contour of the surface of the body.

18. A mount for a control device for a bicycle, the mount comprising:
a securing portion disposable around an outer surface of a handlebar of the bicycle;
a housing portion extending away from the securing portion;
a cavity within at least the housing portion; and
an opening through the housing portion to the cavity;
wherein the housing portion defines an opening through the housing portion to the cavity, and
wherein a size of the opening is smaller than a size of the cavity.

19. The mount of claim 18, further comprising:
a shoulder extending from the housing portion and defining the opening through the housing portion to the cavity.

20. The mount of claim 18, further comprising:
a first fastener receiving portion extending from the securing portion; and
a second fastener receiving portion extending from the securing portion,
wherein the second fastener receiving portion is disposed opposite the first fastener receiving portion with respect to a central axis of the securing portion.
